(19) United States
(12) Patent Application Publication
(10) Pub. No.: US 2006/0236732 A1
(43) Pub. Date: Oct. 26, 2006

(54) Vibration-protected casement lock

(75) Inventor: Rainer Hoffman, Langenfeld (DE)

Correspondence Address: ROBERT W. BECKER & ASSOCIATES, Suite B, 707 Highway 66 East, Tijeras, NM, 87059, US

(73) Assignee: EMKA Beschlagteile GmbH & Co. KG, Velbert (DE)

(21) Appl. No.: 11/401,808

(22) Filed: Apr. 11, 2006

(30) Foreign Application Priority Data
Apr. 11, 2005 (DE) 20 2005 005 774.6

(51) Int. Cl. E05B 65/06

(52) U.S. Cl. 70/127

(57) ABSTRACT

A casement lock operable with a key or wrench and comprising a locking core rotatably disposed in a lock housing and carrying a locking tongue that rotates therewith. An operating shaft, engageable by the key or wrench, is disposed in the housing and is displaceable relative to the locking core against the force of a spring. An arresting pin carried by the operating shaft projects radially beyond the periphery thereof, extends through an axially extending slot of the locking core, and extends into a guide slot of the lock housing. The guide slot has two axially extending arresting recesses for the arresting pin associated with pivot positions of the pin corresponding to the locked and unlocked positions of the locking tongue. The guide slot also has a circumferentially extending guide channel that communicates with the arresting recesses and corresponds to rotational movement of the operating shaft with its arresting pin.

### BACKGROUND OF THE INVENTION

The present invention relates to a casement or rotary lock that can be operated by means of a key or wrench and comprises a locking core, which is placed in a lock housing in such a way that it can be pivoted and arrested, and which serves to carry a locking tongue that is attached to the locking core so as to move with it.

A vibration-protected casement lock having the aforementioned features is known from EP 0 175 211 B1. If the intension is to avoid an independent pivoting of the locking core that carries the locking tongue, e.g. due to vibrations that affect the casement lock, a disc-shaped mask is placed into the circular space between the lock housing and a locking core located in the housing and having an actuation extension for accepting a key or wrench and enclosed by the lock housing. The disc-shaped mask can be moved in the axial direction against the force of a spring. On the one hand, the mask is connected to the locking core in a formfitting manner and is guided on the locking core; on the other hand, when the key is removed, the spring force causes the mask to assume the front position that covers the lock housing and interlock with the lock housing in a formfitting manner. Hence, when the key is removed, an independent pivoting of the locking core that carries the locking tongue is impossible for the mask cannot pivot in relation to the lock housing because it is connected both to the locking core and to the lock housing in a formfitting manner.

Associated with the known casement lock is the disadvantage that the arresting of the locking core only functions when the key or wrench is removed, for the mask can only interlock with the lock housing in its front position. However, situations may occur in which it can be desirable to leave the key engaged, whereby the protection against vibration in that operating situation is also to be provided. In addition, the interlocking of the disk-shaped mask with the lock housing provides only comparatively small interlocking surfaces. That raises the question if the operating safety of the vibration-protected casement lock can be ensured for many years.

It is therefore an object of the present application to provide a vibration-protected casement lock or latch having the aforementioned features, whereby the protection against vibration is guaranteed independent from the key function. Additionally, the stability for the arresting of the locking core in relation to the lock housing is to be improved.

The fundamental concept of the invention is that an operating shaft is located in the lock housing. The operating shaft, due to the pressure of a key or wrench that is to engage the operating shaft, can be moved in relation to a locking core against the force of a spring that is supported on the locking core. The operating shaft carries an arresting pin, which radially projects beyond the periphery of the operating shaft, extends through an axially extending oblong hole or slot of the locking core and reaches into a guide slot that is located on the lock housing. The guide slot comprises two axial arresting recesses for the arresting pin that are associated with the pivoting positions of the arresting pin in the locked and in the unlocked position of the locking tongue; it further comprises a guide channel that extends in a circumferential direction and corresponds to the pivoting movement of the operating shaft with the arresting pin. The invention is therefore based on the principle that the key cooperates with an operating shaft that is axially movable in relation to the locking core, which serves to carry the locking tongue. Via an attached arresting pin, the operating shaft is guided in a guide slot, which is located in the lock housing, and it is secured in both pivoting positions by means of corresponding arresting recesses that are part of the guide slot. The arresting pin establishes a connection between the operating shaft and the locking core that impedes pivoting of the two in relation to each other. Since the operating shaft is arrested in relation to the lock housing, the locking core is simultaneously arrested so as to not be pivotable relative to the lock housing. Unwanted pivoting movements of the locking core are therefore reliably prevented.

The invention hence has the advantage that the operating shaft into which the key or wrench is engaged directly impels the rotation of the locking core via the arresting pin that is fixedly attached to the operating shaft and extends through the locking core. In the two end positions of the key that correspond to the locked and to the unlocked position of the locking tongue, the operating shaft is simultaneously directly arrested to the lock housing by means of the arresting pin in the guide slot of the lock housing. A transfer of large forces is therefore possible. Since both the locked and the unlocked position of the locking tongue are independently from each other associated to a separate locking position of the arresting pin, the arresting of the operating shaft to the lock housing does not depend on whether the key is applied or removed. The protection against vibration is caused solely by the respective pivot position of the operating shaft in relation to the lock housing.

The transfer of force is improved provided that the arresting pin projects in a symmetrical arrangement on both sides of the operating shaft and that the locking core has two associated oblong holes through which the arresting pin extends and further provided that the lock housing has two guide slots that receive the two ends of the arresting pin.

According to one embodiment of the invention, the transitions between the arresting recesses and the guide channel of the guiding slot are configured with a rounding in order to improve the pivoting of the key or wrench and, associated with that, the pivoting of the locking core with the arresting pin that extends through the locking core.

The guide slot is formed by an aperture located in the wall of the lock housing, according to one embodiment of the invention.

In order to configure a lock housing that is closed on its outside, the guide slot can alternatively be formed by an aperture or cutout located in the wall of a control sleeve that can be introduced into the lock housing in a formfitting manner so as to not be pivotable. The guide slot can hereby be entirely formed in the control sleeve. In an alternative modified embodiment of the invention, the guide slot with the arresting recesses and the guide channel is formed by the aperture of the control sleeve in conjunction with recesses that are located on the inside of the lock housing.

In a first embodiment, with regard to the configuration of the operating shaft and the locking core, the locking core is configured sleeve-shaped and the operating shaft, which comprises an axially protruding single-piece multi-sided projection, is inserted into the locking core. In this embodiment, the key or wrench is placed directly onto the operating shaft and the operating shaft is pivoted in that manner.

If, in this embodiment, the front axial area in the lock housing has to be freely accessible for the application of the key or wrench, the operating shaft comprises, according to one embodiment of the invention, a collar that is—in the axial direction—adjacent to the multi-sided projection. The collar is located inside the sleeve-shaped locking core and serves for covering the inner space of the locking core. On its outside, the collar of the operating shaft is expediently provided with a gasket.

In an alternative embodiment, the configuration of the operating shaft is only modified insofar as the operating shaft itself is configured sleeve-shaped. It encloses a multi-sided projection that axially protrudes from the locking core in such a way that when the key or wrench is applied, the outer edge surface at the end of the sleeve-shaped operating shaft forms the key receiving means, and the multi-sided projection that is connected to the locking core forms the guide means for the key. In this embodiment, the key is applied to the protruding multi-sided projection. During that applying motion, the key moves the sleeve-shaped operating shaft in the lock housing in the axial direction. The key is hence to be brought into engagement with the multi-sided projection of the locking core. When the key is pivoted, the locking core together with the sleeve-shaped operating shaft that carries the arresting pin pivot correspondingly.

According to a further embodiment of the invention, the operating shaft is configured sleeve-shaped and can be introduced into the sleeve-shaped locking core. At the opening at its end, the operating shaft is provided with the key receiving means for the application of a key or wrench. A guide pin that serves for accepting the key is located inside the sleeve-shaped operating shaft. The guide pin extends through the wall of the operating shaft in associated oblong holes or slots and is fixedly attached to the locking core that encloses the operating shaft. In this embodiment, the operating shaft itself, which is inserted into the sleeve-shaped locking core, is at least partially configured sleeve-shaped. Hence, a guide pin that serves as guide means for the key when the key is applied is placed into the operating shaft. The shape of the opening at the end of the operating shaft hereby corresponds to the contour of a two-way key in such a way that the sleeve-shaped operating shaft is moved in relation to the locking core when the two-way key is applied to the guide pin. Since the guiding pin is fixedly attached to the locking core and therefore remains in its position, the wall of the sleeve-shaped operating shaft is provided with oblong holes that enable the corresponding relative movement of the operating shaft in relation to the guide pin.

### BRIEF DESCRIPTION OF THE DRAWINGS

Embodiments of the invention, which are described below, are represented in the drawings, in which:

FIG. 1 shows the components of a vibration-protected casement lock in an exploded perspective representation,

FIG. 2 shows the assembled casement lock according to FIG. 1 in a sectioned view,

FIG. 3 shows a different embodiment of the vibration-protected casement lock in a representation analogous to FIG. 1,

FIG. 4 shows the assembled casement lock according to FIG. 3 in a sectioned view,

FIG. 5 shows a further embodiment of the vibration-protected casement lock in a representation analogous to FIGS. 1 or 3,

FIG. 6 shows the assembled casement lock according to FIG. 5 in a sectioned view,

FIG. 7 shows the components of a modified embodiment of the vibration-protected casement lock analogous to embodiment represented in FIGS. 3 and 4 in an exploded perspective representation,

FIG. 8 shows the partially assembled casement lock according to FIG. 7, and

FIG. 9 shows the casement lock according to FIGS. 7 or 8 in a perspective sectioned view.

### DESCRIPTION OF SPECIFIC EMBODIMENTS

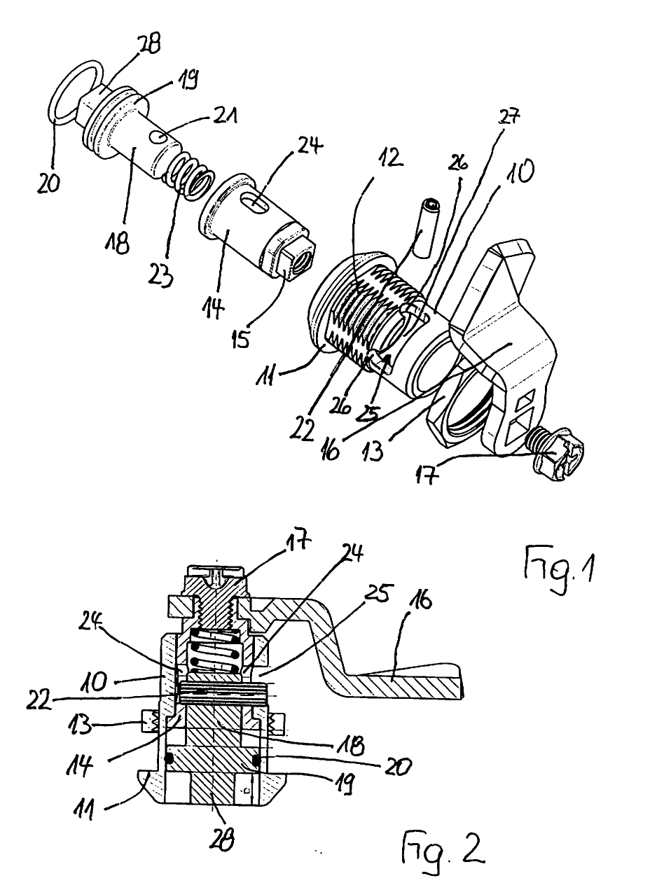

The configuration of the casement lock according to the invention is initially explained with the aid of the representation in FIG. 1. A lock housing 10 has a flange 11 located on its front, left end. When the casement lock is mounted, e.g. on a door panel, the flange 11 rests against the outside of a corresponding door opening that holds the lock housing 10 and is supported on the door panel. In the area adjacent to the flange 11, the lock housing 10 is provided with a thread 12, onto which a nut 13 can be screwed. When mounting the casement lock, e.g. on a door panel, the door panel is clamped between the flange 11 and the nut 13, and the lock housing 10 is therefore fixedly attached. A locking core 14 is arranged in the lock housing 10 so as to be pivotable. The end of the locking core 14 that can be introduced into the lock housing 10 is configured as a square end 15, on which a locking or latching tongue 16 can be mounted in a formfitting manner. Subsequently, the locking tongue 16 can be fixedly attached to the locking core 14 by means of an attachment bolt 17.

In the embodiment represented here, the locking core 14 is configured sleeve-shaped so that an operating shaft 18 can be introduced into the locking core 14. On its front, left end, the operating shaft 18 has a multi-sided projection 28 for the application of a corresponding key or wrench. Adjacent to the multi-sided projection 28 is a collar 19; a gasket 20 can be placed onto the outer periphery of the collar 19 so that the operating shaft 18—after introducing it into the sleeve-shaped locking core 14—seals the interior space of the locking core 14. A compression spring 23 is located between the sleeve-shaped locking core 14 and the operating shaft 18, which pretensions the operating shaft 18 in its front position in the locking core 14. When pressure is applied onto the operating shaft 18 relative to the locking core 14 by means of the not represented key, the operating shaft 18 can be pushed into the locking core 14.

The operating shaft 18 comprises an arresting pin 22 that radially protrudes beyond the periphery of the operating shaft 18 and is placed into a fitted or reamed hole 21. The arresting pin 22 extends through an oblong hole 24 that is located in the wall of the sleeve-shaped locking core 14, hence enabling the relative movement of the operating shaft 18 in relation to the locking core 14. The arresting pin 22 engages into and is guided in a guide slot 25 that is located in the wall of the lock housing 10. The guide slot 25 comprises two axially arranged arresting recesses 26, which are located on the periphery of the lock housing 10 and are offset from each other by the possible angle of rotation of the operating shaft 18. A guide channel 27 for the arresting pin 22, which corresponds to the pivoting movement of the operating shaft 18 with the arresting pin 22, is located between the arresting recesses 26. The two axial arresting recesses 26 are thereby equivalent to the pivoting position of the operating shaft 18 in the locked position and the unlocked position, respectively, of the locking tongue 16.

In the initial position, the arresting pin 22 that is carried by the operating shaft 18 lies in one of the axial arresting recesses 26 and is arrested in the associated arresting recess 26 due to the effect of the spring 23, which pushes the operating shaft 18 outwardly. In this first and initial position, vibrations that occur cannot cause a pivoting of the locking tongue 16.

If the casement lock is actuated by means of a key of wrench that is applied to the multi-sided projection 28 of the operating shaft 18, the operating shaft 18 is pushed, against the force of the spring 23, into the sleeve-shaped locking core 14 with the key. During that pushing-in motion, the arresting pin 22 that lies in the axial arresting recess 26 guides the operating shaft 18 so that it cannot pivot. When the arresting pin 22, after leaving the arresting recess 26, reaches the guide channel 27, the operating shaft 18 can be pivoted with the key. The arresting pin 22 thereby travels through the guide channel 27 until it is stopped in the area of the other arresting recess 26 and can here engage into the other axial arresting recess 26 by means of the axial backward movement. The pivoting movement of the operating shaft 18 is hence converted, via the arresting pin 22 that lies in the oblong hole or slot 24 of the sleeve-shaped locking core 14, into a pivoting movement of the locking core 14 and therefore of the locking tongue 16 that is attached to the locking core 14 so as to move with it. When, at the end of the pivoting movement, the opposite axial arresting recess 26 is reached, the spring 23 pushes the operating shaft 18 into its front position again. Likewise, the locking core 14 with the attached locking tongue 16 is arrested securely in this other end position.

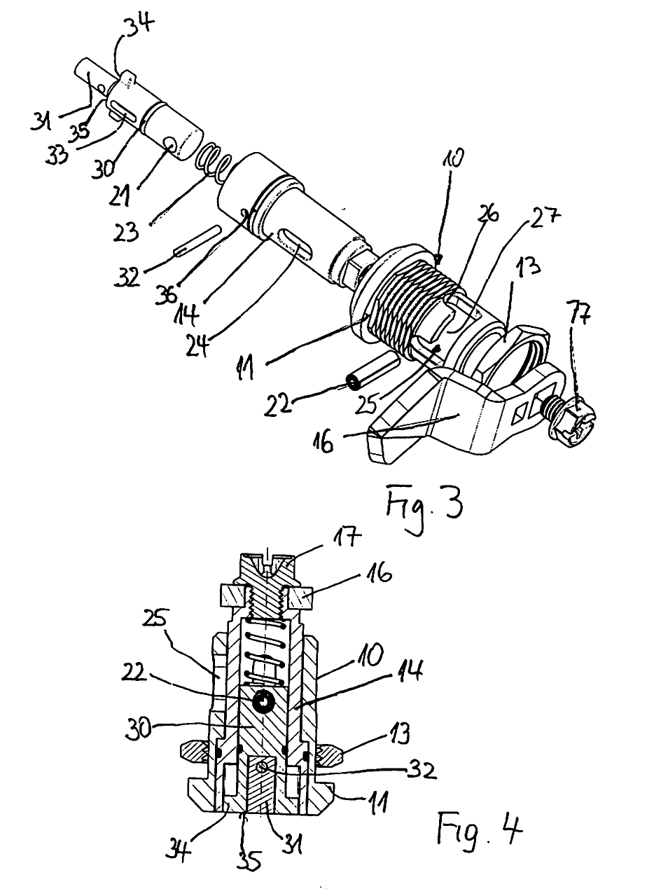

In the embodiment represented in FIGS. 3 and 4, in distinction to the embodiment described above, the operating shaft 30 itself is configured sleeve-shaped, so that the key can be introduced into the operating shaft 30. An axially extending guide pin 31 that serves for guiding the key is coupled to the sleeve-shaped operating shaft by means of a holding pin 32, which extends through the wall of the sleeve-shaped operating shaft 30 in a transverse direction and engages into fitted holes 36 in the sleeve-shaped locking core 14. In order to enable a relative axial movement of the sleeve-shaped operating shaft 30 in relation to the holding pin 32 that is fixedly attached to the locking core 14, the wall of the operating shaft 30 is provided with oblong holes or slots 33. The opening 35 at the end of the sleeve-shaped operating shaft 30, due to side extensions 34, has the shape of a two-way key. If therefore a two-way key is applied to the operating shaft 30, the guide pin 31 engages into the central opening of the two-way key and guides the key during the introducing motion into the lock housing 10. In the course of that introducing motion, the contours of the two-way key engage into the opening 35 with the side extensions 34 at the end of the operating shaft 30, so that the operating shaft 30 is moved in the axial direction and relative to the sleeve-shaped locking core 14. If the arresting pin 22 is coupled to the operating shaft 30, the further movement sequence occurs as described in accordance with FIGS. 1 and 2.

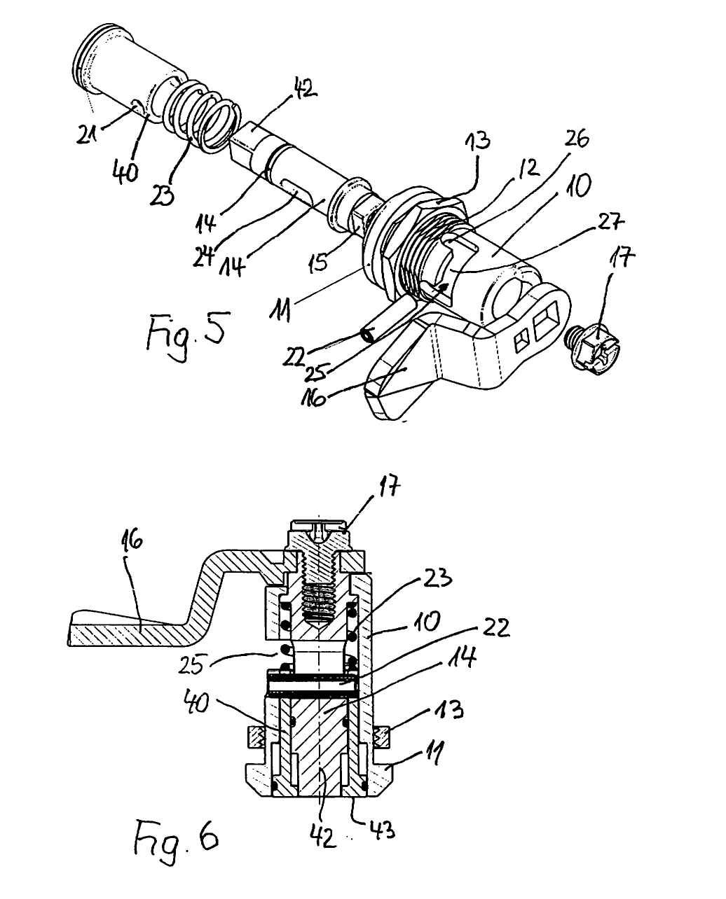

In the embodiment represented in FIGS. 5 and 6, in distinction to the embodiment described in accordance with FIGS. 1 and 2, the conditions are reversed insofar as the locking core 41 is now solid and the operating shaft 40 encloses the outside of the locking core 41 in a sleeve-like manner. Furthermore, the operating shaft 40 is pivotable in the lock housing 10. Located on its end, the locking core 41 has a multi-sided projection 42 for the application of a key or wrench. The arresting pin 22 is placed into the fitted hole 21 of the operating shaft 40. The outer end of the arresting pin 22 is once again guided in the guide slot 25 of the lock housing 10, while its inner end reaches into an oblong hole 24 that is located in the locking core 14.

The sleeve-shaped operating shaft 40 has a circular edge surface 43 that encloses the multi-sided projection 42 of the locking core 41 that lies within. When the key or wrench is applied to the multi-sided projection 42, the operating shaft 40 is moved, due to pressure applied to the surface 43, in the axial direction relative to the locking core 14. Hereafter, the same movements apply as described in accordance with FIGS. 1 and 2.

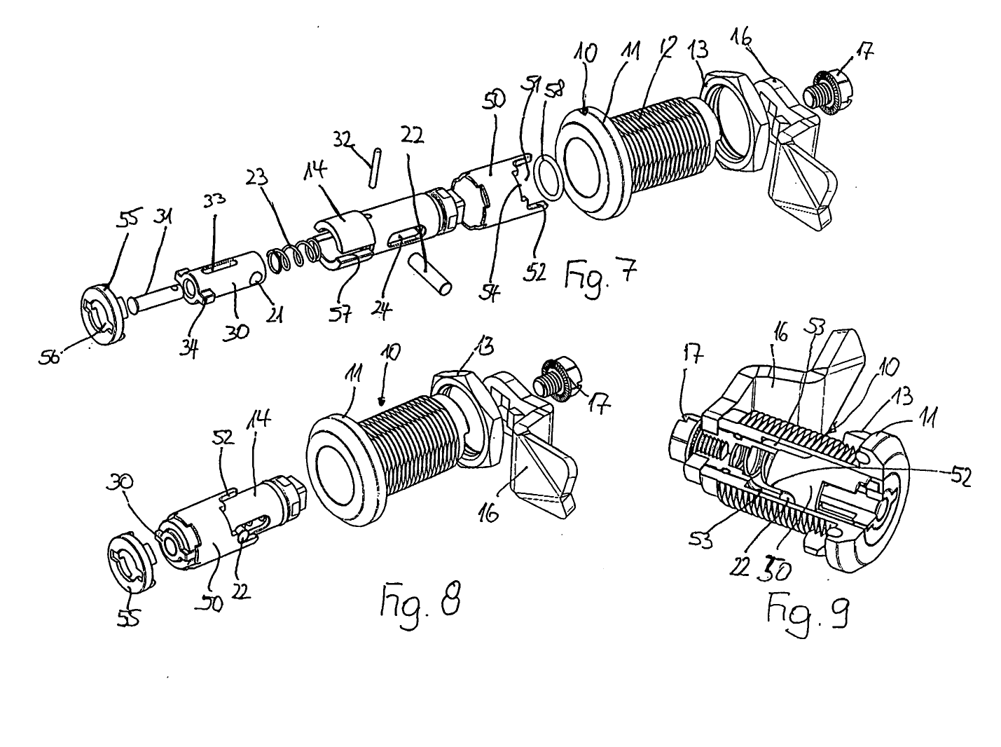

The fundamental configuration of the embodiment represented in FIGS. 7 through 9 is equivalent to the embodiment that is shown in FIGS. 3 and 4 and correspondingly described in detail. The main difference is that the guide slot 25 with the axial arresting recesses 26 and the guide channel 27 is not formed by a cutout or aperture in the housing wall of the lock housing 10, but by a control sleeve 50, which, when the lock housing 10 is closed, is located inside the lock housing 10. The control sleeve 50 has a cutout 51 that forms guide edges 52. As a counterpart, recesses 53 for the arresting pin 22 are located on the inside of the lock housing 10 (see FIG. 9). The recesses 53 in conjunction with the guide edges 52 of the cutout 51 of the control sleeve 50 form the guide slot 25. The cutouts 51 of the control sleeve 50, which are located opposite from each other on the control sleeve 50, each extend into a further axially adjoining opening 54 that is intended to interact with a respective not represented projection located on the inside of the lock housing 10. By means of the projections engaging into the corresponding opening 54, the control sleeve 50 is coupled to the lock housing 10 and arrested so as to not be pivotable in relation to the lock housing 10. The configuration is supplemented by the provision of a gasket 58. In this embodiment, the opening at the end of the lock housing 10 is covered with a holding cap 55, which is provided with an insert opening 56 that serves for the introduction of a two-way key. When the two-way key is introduced, it acts upon the operating shaft 30 with the side extensions 34, which are now guided in slots 57 of the locking core 14. In other respects, the configuration and functioning of the safety casement lock according to FIGS. 7 through 9 are equivalent to the embodiment according to FIGS. 3 and 4.

The features of the subject matter of these documents, disclosed in the above description, in the patent claims and in the drawing, can separately or in any combination with each other be essential for the implementation of the invention in its various embodiments.

The specification incorporates by reference the disclosure of German priority document DE 20 2005 005 774.6 filed 11 Apr. 2005.

The present invention is, of course, in no way restricted to the specific disclosure of the specification and drawings, but also encompasses any modifications within the scope of the appended claims.

1. A casement lock operable with a key or wrench, comprising:
a lock housing having a guide slot;
a locking core that is rotatably disposed in said lock housing, wherein said locking core carries a locking tongue that is secured to said locking core so as to rotate therewith;
an operating shaft disposed in said lock housing, wherein said operating shaft is adapted to be engaged by a key or wrench, and wherein said operating shaft is displaceable relative to said locking core, via pressure from the key or wrench, against the force of a spring that is supported against said locking core; and
an arresting pin carried by said operating shaft, wherein said arresting pin projects radially beyond a periphery of said operating shaft, wherein said arresting pin extends through an axially extending slot of said locking core, wherein said arresting extends into said guide slot of said lock housing, wherein said guide slot is provided with two axially extending arresting recesses for said arresting pin that are associated with pivot positions of said arresting pin corresponding to a locked and an unlocked position of said locking tongue, and wherein said guide slot is also provided with a circumferentially extending guide channel that communicates with said arresting recesses and corresponds to a rotational movement of said operating shaft with its arresting pin.

2. A casement lock according to claim 1, wherein said arresting pin projects radially beyond opposite sides of the periphery of said operating shaft in a symmetrical arrangement, wherein said locking core has two slots through which said arresting pin extends, and wherein said lock housing has two guide slots for receiving the two ends of said arresting pin.

3. A casement lock according to claim 1, wherein transitions between said arresting recesses and said guide channel of said guide slot of said lock housing are rounded.

4. A casement lock according to claim 1, wherein said guide slot is formed by an aperture in a wall of said lock housing.

5. A casement lock according to claim 1, which includes a control sleeve that is adapted to be placed into said lock housing in a positive and non-rotational manner, and wherein said guide slot is formed by a cutout in a wall of said control sleeve.

6. A casement lock according to claim 5, wherein said cutout of said control sleeve, in conjunction with recesses provided on an inner surface of said lock housing, form said arresting recesses and said guide channel of said guide slot.

7. A casement lock according to claim 1, wherein said locking core has a sleeve-shaped configuration, wherein said operating shaft has a monolithic, axially protruding multi-sided projection, and wherein said operating shaft is inserted into said locking core.

8. A casement lock according to claim 7, wherein said operating shaft is provided with a collar that is disposed axially adjacent said multi-sided projection and is disposed in said sleeve-shaped locking core, and wherein said collar is adapted to cover an inner space of said locking core.

9. A casement lock according to claim 8, wherein an outer surface of said collar of said operating shaft is provided with a gasket.

10. A casement lock according to claim 1, wherein a multi-sided projection projects axially from said locking core, and wherein said operating shaft has a sleeve-shaped configuration and encloses said multi-sided projection in such a way that upon application of the key or wrench, an outer edge surface at an end of said sleeve-shaped operating shaft forms a receiving means for the key or wrench, and said multi-sided projection of said locking core forms a guide means for the key or wrench.

11. A casement lock according to claim 1, wherein said locking core is configured as a sleeve, wherein said operating shaft has a sleeve-shaped configuration and is adapted to be inserted into said locking core, wherein an opening at an end of said operating shaft forms a receiving means for application of a key or wrench, wherein a guide pin for receiving the key or wrench is disposed in said sleeve-shaped operating shaft, and wherein said guide pin extends through slots in a wall of said operating shaft and is fixed in said locking core.

12. A casement lock according to claim 11, wherein said opening pin in the end of said operating shaft has a configuration in the shape of the contour of a two-way key.
